(19) United States
(12) Patent Application Publication
(10) Pub. No.: US 2026/0002907 A1
(43) Pub. Date: Jan. 1, 2026

(54) Systems and Methods for Iterative Ion Mobility Separations

(71) Applicant: MOBILion Systems, Inc., Chadds Ford, PA (US)

(72) Inventors: Liulin Deng, Chester Springs, PA (US); John Daniel DeBord, West Grove, PA (US)

(73) Assignee: MOBILion Systems, Inc., Chadds Ford, PA (US)

(21) Appl. No.: 19/251,883

(22) Filed: Jun. 27, 2025

Related U.S. Application Data
(60) Provisional application No. 63/665,747, filed on Jun. 28, 2024.

(51) Int. Cl. G01N 27/623

(52) U.S. Cl. CPC G01N 27/623

(57) ABSTRACT

A method of separating ions based on mobility is provided. The method involves receiving ions by an ion mobility spectrometry device having a separation region, and causing the ions to travel through at least a portion of the separation region in a first direction along a path and separate based on ion mobility. The method further involves causing the separated ions to maintain a relative degree of separation therebetween and travel in a second direction along the path while maintaining the relative degree of separation therebetween. The second direction being opposite to the first direction. The ions are then caused to travel in the first direction along the path a second time to further separate the ions based on ion mobility. An ion mobility spectrometry device performing the foregoing method is also provided.

### CROSS-REFERENCE TO RELATED APPLICATIONS

The present application claims the benefit of priority to U.S. Provisional Patent Application Ser. No. 63/665,747 filed on Jun. 28, 2023, entitled Systems and Methods for Iterative Ion Mobility Separations, and is herein incorporated by reference in its entirety.

### TECHNICAL FIELD

The present disclosure relates generally to the fields of ion mobility spectrometry (IMS) and mass spectrometry (MS). More specifically, the present disclosure relates to systems and methods for iterative ion mobility separations.

### RELATED ART

IMS is a technique for separating and identifying ions in the gaseous phase based on their mobilities. For example, IMS can be employed to separate structural isomers and macromolecules that have different mobilities. IMS relies on applying a constant or a time-varying electric field to a mixture of ions within a static or dynamic background gas. An ion having a larger mobility (or smaller collision cross section [CCS]) moves faster under the influence of the electric field compared to an ion with a smaller mobility (or larger CCS). By applying the electric field over a separation distance of an IMS device, ions from an ion mixture can be temporally or spatially separated based on their mobility. Because ions with different mobilities arrive at the end of the IMS device at different times (temporal separation) they can be identified based on the time of detection by a detector positioned downstream of the IMS device. Resolution of the mobility separation can be varied by changing the separation distance.

MS is an analytical technique that can separate a mixture of chemical species based on their mass-to-charge ratio. MS involves ionizing the mixture of chemical species followed by acceleration of the ion mixture in the presence of electric and/or magnetic fields. In some mass spectrometers, ions having the same mass-to-charge ratio undergo the same deflection or time dependent response. Ions with different mass-to-charge ratios can undergo different deflections or time dependent response, and can be identified based on the spatial or temporal position of detection by a detector (e.g., electron multiplier).

IMS combined with MS can generate an IMS-MS spectrum that can be used in a broad range of applications, including metabolomics, glycomics, and proteomics. IMS-MS ion separation can be performed by coupling an ion mobility spectrometer with a mass spectrometer. For example, an ion mobility spectrometer can first separate the ions based on their mobility. Ions having different mobilities can arrive at the mass spectrometer at different times, and are then separated based on their mass-to-charge ratio. One example of an IM spectrometer is a structures for lossless ion manipulations (SLIM) device that can generate an IMS spectrum with minimal ion loss. SLIM devices can use traveling wave separation as one technique to separate ions of different mobilities.

For IMS and IMS-MS systems, the IM resolution can be increased by increasing the separation distance, which significantly enhances ion mobility separation power. Various methods have been employed by prior art systems to increase the separation distance. For example, some systems utilize longer physical path lengths through which the ions travel and are separated. However, this results in a larger footprint, e.g., a large printed circuit board (PCB), which results in a larger overall device. Other systems artificially increase the separation distance by utilizing a path that loops back upon itself, e.g., an additional path is provided from the end of the path to the beginning or the path is a circular loop that the ions must enter and exit, such that the ions make multiple passes around the same loop, e.g., a multipass design. This allows the path length to be increased to hundreds or even thousands of meters, and can achieve ultra-high resolution ion mobility (UHRIM) separations. However, these systems often require an additional path that guides the ions from the exit of the long separation path back to the entrance to perform additional ion mobility separation cycles. This multipass IMS design is complex in nature, as it can require an ion switch to direct ions to either the entrance of the separation path or to a downstream MS system. Additionally, this functionality cannot be implemented on an IMS device that is not already manufactured with a multipass configuration design, e.g., the IMS device must be specifically designed and manufactured with this multipass configuration in mind.

Accordingly, there is a need for additional systems and methods for iterative ion mobility separations that can achieve ultra-high resolution ion mobility separation that overcome the foregoing shortcomings of the prior art.

### SUMMARY

The present disclosure relates to systems and methods for iterative ion mobility separations.

A method of separating ions based on mobility is provided. The method involves receiving ions by an ion mobility spectrometry device having a separation region, and causing the ions to travel through at least a portion of the separation region in a first direction along a path and separate based on ion mobility. The method additionally involves causing the separated ions to maintain a relative degree of separation therebetween and travel along the path in a second direction, which is opposite to the first direction, while maintaining the relative degree of separation therebetween. The method also involves causing the ions to travel in the first direction along the path a second time and further separate the ions based on ion mobility.

In some aspects, the method can involve accumulating ions in an accumulation region of the ion mobility spectrometry device and releasing the ions accumulated in the accumulation region into the separation region.

In other aspects, the step of causing the ions to travel through at least a portion of the separation region in a first direction along a path can include generating a first traveling wave potential in the separation region that causes the ions to travel in the first direction along the path and separate based on ion mobility, while the step of causing the separated ions to maintain a relative degree of separation therebetween and travel in a second direction along the path can include generating a second traveling wave potential in the separation region that causes the separated ions to maintain the relative degree of separation therebetween and travel in the second direction along the path while maintaining the relative degree of separation therebetween. In such aspects, the first traveling wave potential can include a first speed and a first amplitude, and the second traveling wave potential can include (a) a second speed that is less than the first speed, (b) a second amplitude that is greater than the first amplitude, or (c) a second speed that is less than the first speed and a second amplitude that is greater than the first amplitude.

In some aspects, the ion mobility spectrometry device can be a structures for lossless ion manipulations (SLIM) device.

In other aspects, the path can extend from a beginning of the separation region to an end of the separation region.

In still other aspects, the method can involve selectively removing a portion of the ions from the separation region. In such aspects, selectively removing a portion of the ions from the separation region can include activating an electrode positioned upstream of the separation region to eliminate the portion of the ions, activating an electrode positioned downstream of the separation region to eliminate the portion of the ions, and/or activating a switch to remove the portion of the ions from the separation region. In some such aspects, selectively removing a portion of the ions from the separation region can involve storing the portion of the ions that have been removed for subsequent analysis.

An ion mobility spectrometry device for separating ions based on mobility is provided. The ion mobility spectrometry device includes a separation region that receives ions, and a path extending through at least a portion of the separation region. The ion mobility spectrometry device causes the ions received by the separation region to travel through at least a portion of the separation region in a first direction along the path and separate based on ion mobility. The ion mobility spectrometry device also causes the separated ions to maintain a relative degree of separation therebetween and travel along the path in a second direction, which is opposite to the first direction, while maintaining the relative degree of separation therebetween. The ion mobility spectrometry device also causes the ions to travel in the first direction along the path a second time to further separates the ions based on ion mobility.

In some aspects, the ion mobility spectrometry device can include an accumulation region that accumulates ions and releases the accumulated ions into the separation region.

In other aspects, the ion mobility spectrometry device can include a plurality of electrodes positioned within the separation region that generate a first traveling wave potential and a second traveling wave potential. In such aspects, the first traveling wave potential can cause the ions received by the separation region to travel in the first direction along the path and separate based on ion mobility, and the second traveling wave potential can cause the separated ions to maintain the relative degree of separation therebetween and travel in the second direction along the path while maintaining the relative degree of separation therebetween. In other such aspects, the first traveling wave potential can include a first speed and a first amplitude, and the second traveling wave potential can include (a) a second speed that is less than the first speed, (b) a second amplitude that is greater than the first amplitude, or (c) a second speed that is less than the first speed and a second amplitude that is greater than the first amplitude.

In some aspects, the ion mobility spectrometry device can be a structures for lossless ion manipulations (SLIM) device.

In other aspects, the path can extend from a beginning of the separation region to an end of the separation region.

In still other aspects, the ion mobility spectrometry device can include an electrode positioned upstream of the separation region, an electrode positioned downstream of the separation region, and/or a switch and accumulation region. In such aspects, the electrodes can selectively eliminate a portion of the ions. In other such aspects, the switch can selectively remove a portion of the ions from the separation region and the accumulation region can store the portion of the ions that have been removed.

Other features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

The foregoing features of the present disclosure will be apparent from the following Detailed Description of the Invention, taken in connection with the accompanying drawings, in which:

FIG. 1 is a schematic diagram of an exemplary ion mobility spectrometry-mass spectrometry (IMS-MS) system of the present disclosure;

FIG. 2 is a diagrammatic view of a portion of an exemplary IMS device that can be used with the IMS system of FIG. 1 of the present disclosure;

FIG. 3 is a schematic diagram illustrating an exemplary arrangement of electrodes on a surface of the exemplary IMS device of FIG. 2;

FIG. 4 is a block diagram showing exemplary regions of the IMS device of FIG. 1;

FIG. 5 is a plan view of an exemplary printed circuit board for use in the IMS device of FIG. 2 and which includes the exemplary regions of FIG. 4;

FIG. 6 is a schematic diagram illustrating an exemplary accumulation region of the IMS device of FIG. 2;

FIG. 7 is a schematic diagram illustrating a portion of an exemplary ion mobility separation region of the IMS device of FIG. 2;

FIG. 8 is an exemplary timetable illustrating an exemplary sequence of operations performed by the IMS system of FIG. 1;

FIG. 9 is a schematic diagram of the portion of the exemplary ion mobility separation region of FIG. 7 showing a first path through the separation region along which ions travel during an IM separation operation;

FIG. 10 is a schematic diagram of the portion of the exemplary ion mobility separation region of FIG. 7 showing a second path through the separation region along which ions travel during an ion mobility separation preservation and return operation;

FIG. 11 is an exemplary timing control schematic diagram for signals applied to components of the IMS device of the present disclosure;

FIG. 12 is a flowchart illustrating exemplary steps for performing iterative ion mobility separations according to the present disclosure; and

FIG. 13 is a diagram illustrating the traveling wave potentials, including speeds, amplitudes, and directions thereof, during each phase of the iterative ion mobility separation process and the resulting separation of ions.

### DETAILED DESCRIPTION

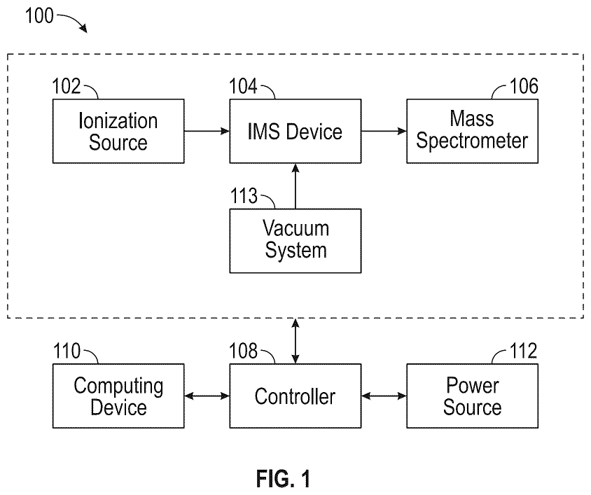

The present disclosure relates to systems and methods for iterative ion mobility separations, as described in detail below in connection with FIGS. 1-13.

Ions can be separated based on their mobility via ion mobility spectrometry (IMS). Mobility separation can be achieved, for example, by applying one or more potential waveforms (e.g., traveling potential waveforms, direct current (DC) gradient, or both) on a collection of ions. IMS based separation can be achieved by structures for lossless ion manipulation (SLIM) devices that can systematically apply AC and/or DC potential waveforms to a collection of ions, such as the devices disclosed and described in U.S. Pat. No. 8,835,839 entitled “Method and Apparatus for Ion Mobility Separations Utilizing Alternating Current Waveforms” and U.S. Pat. No. 10,317,364 entitled “Ion Manipulation Device,” both of which are incorporated herein by reference in their entirety. This can result in a stream of ions that are temporally and/or spatially separated based on their mobility.

The present disclosure utilizes IMS devices, such as SLIM devices, to accumulate ions, transfer ions, and separate ions of different mobilities within the respective IMS device for subsequent separation and analysis. However, it should be understood that the present disclosure is not limited to SLIM devices, but instead encompasses and is applicable to any IMS device known in the art that is capable of performing ion mobility separations using traveling wave potentials. For example, the present disclosure is applicable to SLIM devices, but this approach can also be performed on other IMS devices that can perform ion mobility separations, stop an ion mobility separation in process, and cause the separated ion packets to travel to a different location within the separation region while maintaining their relative degree of separation (e.g., preserve the ion packets in their current separation state).

FIG. 1 is a schematic diagram of an exemplary IMS-MS system 100 according to the present disclosure. The IMS-MS system 100 includes an ionization source 102, an IMS device 104, a mass spectrometer 106, a controller 108, a computing device 110, a power source 112, and a vacuum system 113. The ionization source 102 generates ions (e.g., ions having varying mobility and mass-to-charge-ratios) and injects the ions into the IMS device 104. The IMS device 104 can be configured to accumulate ions, store ions, separate ions, and/or transfer (e.g., surf) ions without separating based on mobility, depending on the desired functionality and waveforms applied thereto. As previously noted, the IMS device 104 can be a SLIM device that can systematically apply AC and/or DC potential waveforms to a collection of ions, such as the devices disclosed and described in U.S. Pat. Nos. 8,835,839 and 10,317,364. SLIM devices are particularly applicable to the present invention as they offer exceptional high-resolution ion mobility performance by minimizing ion loss during transmission. However, the IMS device 104 need not be a SLIM device, but instead can be any IMS device that can perform ion mobility separations, stop an ion mobility separation in process, and cause the separated ions to travel to a different location within a separation region thereof while maintaining their relative degree of separation (e.g., preserve the ion packets in their current separation state). Additionally, the IMS device 104 can be used to separate ions, eliminate ions outside of a predetermined range of mobilities, and direct the ions to a detector, e.g., the mass spectrometer 106. The vacuum system 113 can be in fluidic communication with the IMS device 104 and regulate the gas pressure within the IMS device 104. For example, the vacuum system 113 can provide nitrogen to the IMS device 104 while maintaining the pressure therein at a consistent pressure.

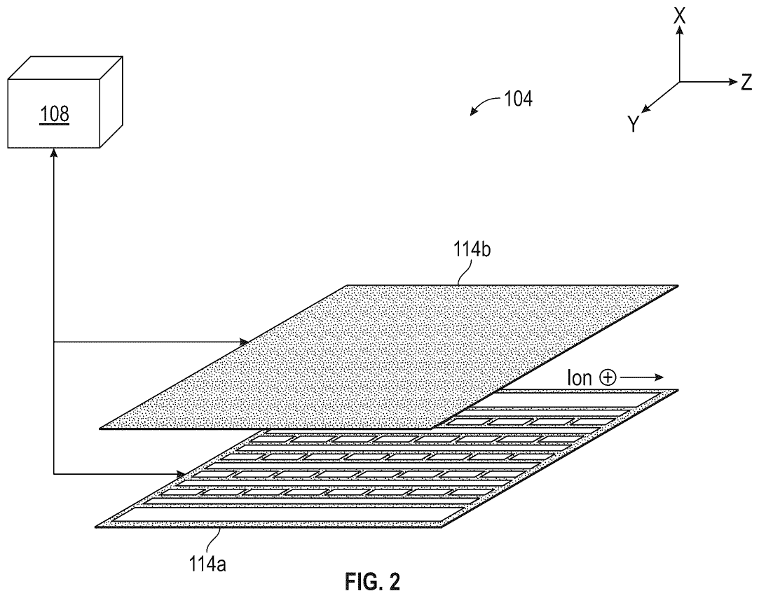

The IMS device 104, particularly when provided as a SLIM device, can include one or more surfaces 114a, 114b (e.g., printed circuit board surfaces) (see FIG. 2) that can have a plurality of electrodes arranged thereon. The electrodes can receive voltage signals, a voltage waveform, and/or a current waveform (e.g., a DC voltage or current, an RF voltage or current, or an AC voltage or current, or a superposition thereof), and can generate a potential (e.g., a potential gradient) to confine ions in the IMS device 104, accumulate ions in the IMS device 104, and guide ions through the IMS device 104, which can result in the accumulation and separation of ions based on their mobility, as discussed in greater detail below.

The controller 108 can control operation of the ionization source 102, the IMS device 104, the mass spectrometer 106, and the vacuum system 114. For example, the controller 108 can control the rate of injection of ions into the IMS device 104 by the ionization source 102, the threshold mobility of the IMS device 104, and ion detection by the mass spectrometer 106. The controller 108 can also control the characteristics and motion of potential waveforms generated by the IMS device 104 (e.g., by applying RF/AC/DC potentials to the electrodes of the IMS device 104) in order to transfer, accumulate, release, separate ions, and/or surf/return ions. The controller 108 can control the properties of the potential waveforms (e.g., amplitude, shape, speed, direction of travel, etc.) by varying the properties of the applied RF/AC/DC potential (or current) and timing of the applied RF/AC/DC potential. In this regard, the controller 108 can vary the properties of the potential waveforms for different regions of the IMS device 104, e.g., different groupings of electrodes, to trap/accumulate ions, release ions, separate ions (e.g., using techniques for iterative ion mobility separations), and/or eliminate ions. This can be done in an effort to increase ion peak resolution, narrow ion peaks, increase signal-to-noise ratio, and achieve sharp separation around a targeted mobility, as discussed in greater detail below.

The controller 108 can receive power from the power source 112, which can be, for example, a DC power source, an AC power source, etc. The controller 108 can include multiple power supply modules (e.g., current and/or voltage supply circuits) that generate various voltage (or current) signals that drive the electrodes of the IMS device 104. For example, the controller 108 can include RF control circuits that generate RF voltage signals, AC control circuits that generate AC traveling wave voltage signals, DC control circuits that generate DC voltage signals, etc. The RF voltage signals, AC voltage signals, and DC voltage signals can be applied to the electrodes of the IMS device 104. The controller 108 can also include a master control circuit that can control the operation of the RF/AC/DC control circuits. For example, the master control circuit can control the amplitude, phase, frequency, and direction of travel of voltage (or current) signals generated by the RF/AC/DC control circuits to achieve a desirable operation of the system 100.

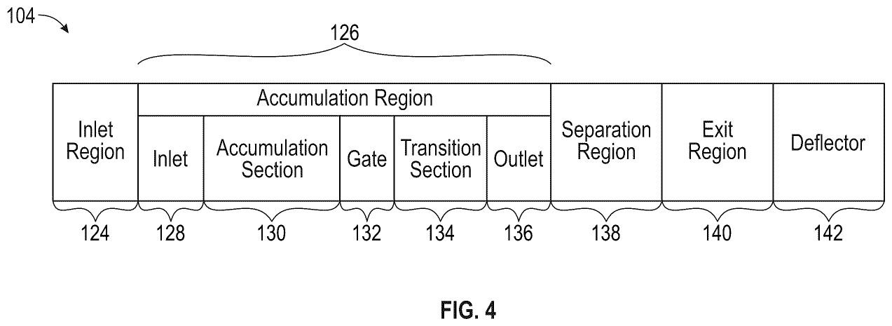

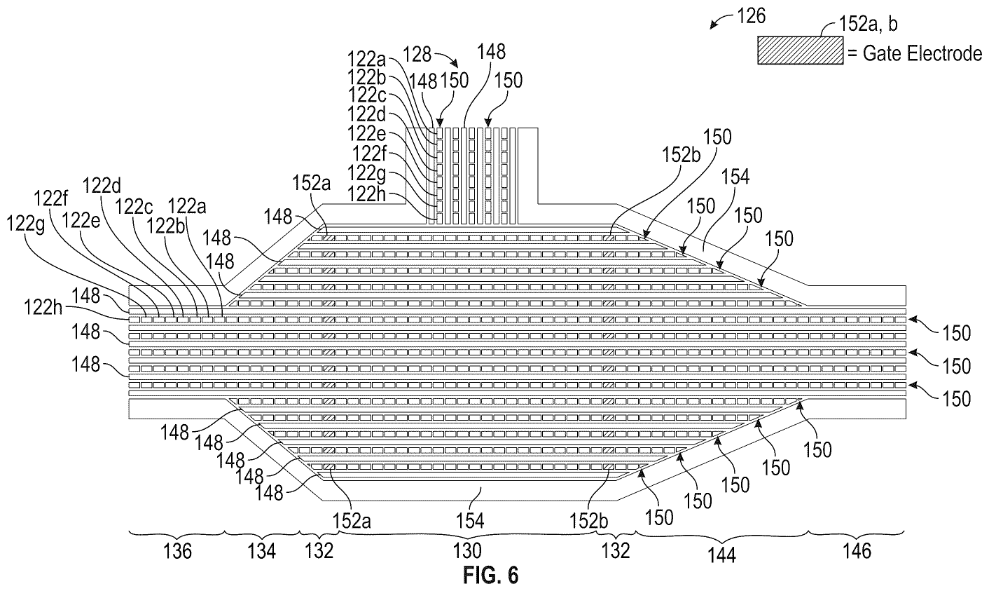

As discussed above, the IMS device 104 can generate traveling potential waveforms (e.g., resulting from potentials generated by multiple electrodes in the IMS device 104) and DC potentials, which can perform mobility-based separations and cause ion accumulation. The traveling potential waveform can travel at a predetermined velocity (e.g., speed) based on, for example, the frequency of the voltage signals applied to the electrodes. In some implementations, the traveling potential waveform can be spatially periodic, and the spatial periodicity can depend on the phase differences between the voltage signals applied to adjacent electrode pairs. In some implementations, the phase differences can determine the direction of propagation of the potential waveform, e.g., forward or reverse, which is discussed in connection with FIGS. 4 and 8-12. In some implementations, the waveform applied to accumulation/trapping/gate electrodes can control accumulation of ions in the IMS device 104, which is discussed in connection with FIG. 6. The master control circuit can control the frequency and/or phase of voltage outputs of RF/AC/DC control circuits such that the traveling potential waveform has a desirable (e.g., predetermined) spatial periodicity, speed, amplitude, and direction of travel in order to separate ions while traveling in a first direction, subsequently preserve the separated ions in their current separation state (e.g., maintain the relative degree of separation between the ions), and cause the ions to travel in a reverse direction while maintaining the relative degree of separation therebetween.

In some implementations, the controller 108 can be communicatively coupled to a computing device 110. For example, the computing device 110 can provide operating parameters of the IMS system 100 via a control signal to the master control circuit. In some implementations, a user can provide the computing device 110 (e.g., via a user interface) with the operating parameters. Based on the operating parameters received via the control signal, the master control circuit can control the operation of the RF/AC/DC control circuits which in turn can determine the operation of the coupled IMS device 104.

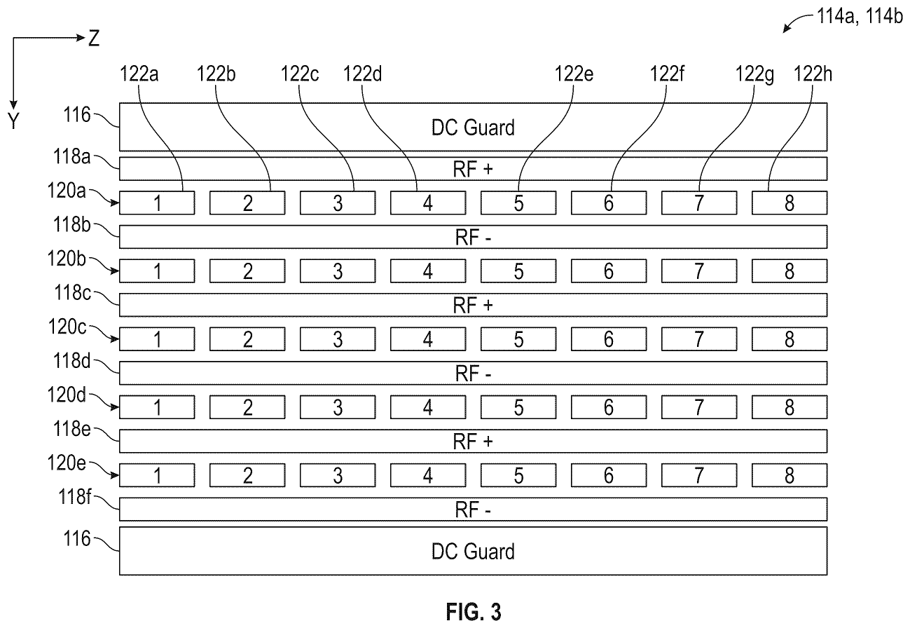

FIG. 2 is a diagrammatic view of a portion of an exemplary IMS device 104 that can be used with the IMS system 100 of FIG. 1. The IMS device 104 shown in FIG. 2 is provided as a SLIM device for accumulating ions, storing ions, separating ions, and/or returning/surfing ions without further separation, and should be understood to be exemplary in nature. That is, the IMS device 104 need not be a SLIM device. The IMS device 104 includes a first surface 114a and a second surface 114b. The first and second surfaces 114a, 114b can be arranged (e.g., parallel to one another) to define one or more ion channels there between. The first surface 114a and the second surface 114b can include electrodes 116, 118a-f, 120a-e, 122a-h (see FIG. 3), e.g., arranged as arrays of electrodes on the surfaces facing the ion channel. The electrodes 116, 118a-118f, 120a-e, 122a-h on the first surface 114a and second surface 114b can be electrically coupled to the controller 108 and receive voltage (or current) signals or waveforms therefrom. In some implementations, the first surface 114a and second surface 114b can include a backplane that includes multiple conductive channels that allow for electrical connection between the controller 108 and the electrodes 116, 118a-f, 120a-e, 122a-h on the first surface 114a and second surface 114b. In some implementations, the number of conductive channels can be fewer than the number of electrodes 116, 118a-f, 120a-e, 122a-h. In other words, multiple electrodes 116, 118a-f, 120a-e, 122a-h can be connected to a single electrical channel. As a result, a given voltage (or current) signal can be transmitted to multiple electrodes 116, 118a-f, 120a-e, 122a-h simultaneously. Based on the received voltage (or current) signals, the electrodes 116, 118a-f, 120a-e, 122a-h can generate one or more potentials (e.g., a superposition of various potentials) that can confine, drive, and/or separate ions along a propagation axis (e.g., z-axis).

FIG. 3 is a schematic diagram of the first and second surfaces 114a, 114b of the IMS device 104 illustrating an exemplary arrangement of electrodes 116, 118a-f, 120a-e, 122a-h thereon. The first and second surfaces 114a, 114b can be substantially mirror images relative to a parallel plane, and thus it should be understood that the description of the first surface 114a applies equally to the second surface 114b, thus the second surface 114b can include electrodes with similar electrode arrangement to the first surface 114a.

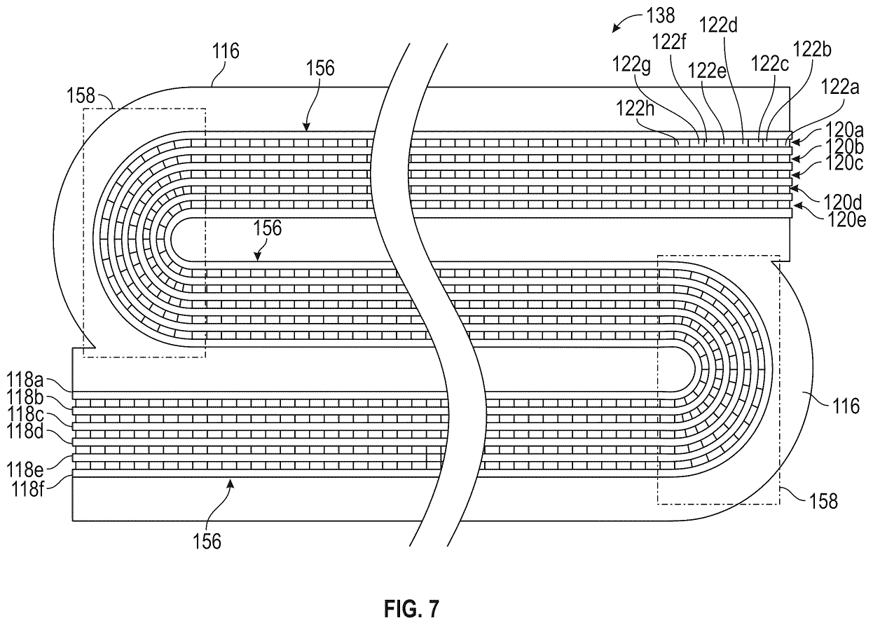

The first surface 114a includes guard electrodes 116, a plurality of continuous electrodes 118a-f, and a plurality of segmented electrode arrays 120a-e. Each of the plurality of continuous electrodes 118a-f can receive RF voltage signals and can generate a pseudopotential that can prevent or inhibit ions from approaching the first surface 114a. The plurality of continuous electrodes 118a-f can be rectangular in shape with the longer edge of the rectangle arranged along the direction of propagation of ions undergoing mobility separation, e.g., along the propagation axis which is parallel to the z-axis shown in FIG. 3. The direction of propagation can also be serpentine in shape (see, e.g., FIG. 7). The plurality of continuous electrodes 118a-f can be separated from each other along a lateral direction, e.g., along the y-axis, which can be perpendicular to the direction of propagation, e.g., the z-axis.

Each of the plurality of segmented electrode arrays 120a-e can be placed between two continuous electrodes 118a-f, and includes a plurality of individual electrodes 122a-h, e.g., eight electrodes, sixteen electrodes, twenty-four electrodes, etc., that are arranged along (parallel to) the direction of propagation, e.g., along the z-axis. It should be understood that each segmented electrode array 120a-e can include more or less than eight electrodes. Additionally, the individual electrodes 122a-h can be separated into individual groups that receive specific signals from the controller 108, discussed in greater detail below. The plurality of segmented electrode arrays 120a-e can receive a second voltage signal and generate a drive potential that can drive ions along the propagation axis or a DC voltage signal that can trap ions, which is discussed in greater detail below. That is, the first and second surfaces 114a, 114b, and the electrode arrangements thereof, can be implemented for different purposes, and thus have different functionalities, based upon the voltage settings applied to the continuous electrodes 118a-f, the segmented electrode arrays 120a-e, and the plurality of individual electrodes 122a-h.

The plurality of continuous electrodes 118a-f and the plurality of segmented electrode arrays 120a-e can be arranged in alternating fashion on the first surface 114a between the DC guard electrodes 116. The segmented electrodes 120a-e can be traveling wave (TW) electrodes such that each of the individual electrodes 122a-h of each segmented electrode array 120a-e receives a voltage signal that is simultaneously applied to all individual electrodes 122a-h, but phase shifted between adjacent electrodes 122a-h along the direction of propagation, e.g., the z-axis. However, the same individual electrodes, e.g., the first individual electrodes 122a, of the segmented electrode arrays 120a-e receive the same voltage signal without phase shifting.

The voltage signal applied to the individual electrodes 122a-h can be a sinusoidal waveform (e.g., an AC voltage waveform), a rectangular waveform, a DC square waveform, a sawtooth waveform, a biased sinusoidal waveform, a pulsed current waveform, etc., and the amplitude of the signal provided to the individual electrodes 122a-h can be determined based on the voltage waveform applied, e.g., in view of the phase shifting referenced above. For example, if a single wavelength of an AC voltage waveform extends over eight electrodes (e.g., the individual electrodes 122a-h), then amplitudes of the voltage signals applied to the individual electrodes 122a-h can be determined by selecting values from the AC waveform for phase shifts corresponding to the total number of electrodes (e.g., eight electrodes) associated with a single wavelength. For example, the phase shift between adjacent electrodes of the individual electrodes 122a-h is 45 degrees (360 degrees of a single wavelength cycle divided by 8). This can be achieved by electrically coupling the individual electrodes 122a-h to different traveling wave control circuits, e.g., AC control circuits, DC (square wave) control circuits, pulsed current control circuits, etc., that generate voltage signals that are phase shifted with respect to each other. Alternatively, the controller 108 could be a single traveling wave control circuit that can generate voltage signals that can be simultaneously applied to the electrodes 122a-h. It should be understood that the voltage or current waveform can take various forms, e.g., square, triangular, rectangular, sawtooth, etc., can be periodic, can be aperiodic, etc. For example, the controller 108 could be a traveling wave control circuit that can include one or more DC (square wave) control circuits that generate DC voltage signals and AC control circuits that generate sinusoidal signals.

As noted above, the controller 108 can include one or more pulsed voltage or current control circuits that can generate a pulsed voltage (or current) waveform, e.g., square, triangular, rectangular, sawtooth, etc. The pulsed voltage (or current) waveform can be periodic with no polarity reversal. The pulsed voltage (or current) control circuits can include multiple outputs that are electrically connected to the individual electrodes 122a-h. In some implementations, the controller 108 can be a pulsed voltage (or current) control circuit that can simultaneously apply multiple voltage signals (e.g., that constitute the pulsed waveform) to each of the individual electrodes 122a-h. The various pulse shapes of the voltage (or current) waveform can be generated by a superposition of DC voltage signals and sinusoidal signals. The controller 108 can determine the phase shift between the voltage signals generated by the various traveling wave control circuits. The shape/periodicity of the traveling potential waveform can be based on the phase shift between the voltage signals applied to adjacent electrodes 122a-h. The controller 108 can determine the amplitudes of the DC voltage signals generated by DC control circuits, and can determine the amplitude, frequency, and other characteristics of the AC signal generated by the traveling wave control circuits.

As time progresses, the potential waveform (e.g., generated by AC waveform, sinusoidal voltage waveform, pulsed voltage [or current] waveform applied to the electrodes) can travel along the direction of propagation, e.g., along the z-axis. This can result in a change in the amplitude of the voltage applied to the individual electrodes 122a-h. For example, the voltage applied to the first individual electrode 122a during a first time step is applied to the adjacent individual electrode 122b during the next time step. The controller 108 can include one or more traveling wave control circuits that can generate the pulsed voltage/current waveform, AC waveform, etc. The controller 108 can control the speed and direction of travel of the traveling potential waveform by controlling the frequency and/or phase of the AC/RF/pulsed voltage (or current) waveform applied to the individual electrodes 122a-h. As the potential waveform travels, ions introduced into the IMS device 104 can be pushed along the direction of propagation and potentially separated based on their mobility, if desired. In this regard, the traveling waveform applied by the controller 108 can be used to transfer the ions without separating them or transfer the ions and separate them based on mobility during the transfer. Additionally, one or more signals can be sequentially applied to the individual electrodes 122a-h as desired. For example, a first signal can be applied to the individual electrodes 122a-h that generates a traveling potential causing ions to travel in a first direction and separate based on mobility, a second signal can be subsequently applied that preserves the separated ions in the current separation state (e.g., maintains the relative degree separation between the ions), and a third signal can thereafter be applied that causes the separated ions to “surf” in a reverse direction, e.g., a second direction opposite to the first direction, without separating or diffusing further. This process can be repeated as many times as desired in order to achieve ultrahigh resolution ion mobility (UHRIM) separations.

The plurality of continuous electrodes 118a-f can be connected to one or more voltage control circuits, e.g., voltage control circuits in the controller 108, and receive RF signals therefrom. The RF voltages applied to the continuous electrodes 118a-f can be phase shifted with respect to adjacent continuous electrodes 118a-f. That is, adjacent continuous electrodes 118a-f can receive the same RF signal, but phase shifted by 180 degrees. Accordingly, in a first state, the first, third, and fifth electrodes 118a, 118c, 118e can have a positive polarity (indicated as RF+) while the second, fourth, and sixth continuous electrodes 118b, 118d, 118f can have a negative polarity (indicated as RF−). As time and the signal advances, the polarity of each of the continuous electrodes 118a-f switches. The foregoing functionality retains the ions between the first and second surfaces 114a, 114b and prevents the ions from contacting the first and second surfaces 114a, 114b.

As noted above, the IMS device 104 can have more or less than eight individual electrodes 122a-h in each of the segmented electrode arrays 120a-e, and can include more or less than five segmented electrode arrays 120a-e and six continuous electrodes 118a-f depending on the functionality desired of the IMS device 104.

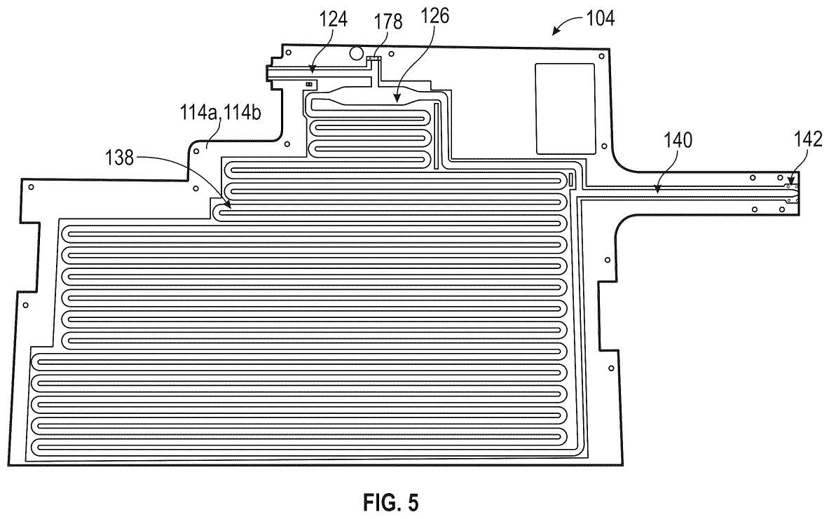

FIG. 4 is a block diagram showing exemplary regions of the IMS device 104, and FIG. 5 is a plan view of an exemplary printed circuit board for use in the IMS device 104 that includes the exemplary regions of FIG. 4. In particular, the IMS device 104 can include an inlet region 124, an accumulation region 126, a separation region 138, an exit region 140, and a deflector 142.

The inlet region 124 is configured to receive ions generated by the ionization source 102, and transfer the received ions to the accumulation region 126. The accumulation region 126, which can also be referred to as an ion trap, is shown in greater detail in FIG. 6 and can be similar to the devices disclosed and described in U.S. Patent App. Pub. No. 2021/0364467 entitled “Methods and Apparatus for Trapping and Accumulation of Ions,” which is incorporated herein by reference in its entirety.

In particular, the accumulation region 126 can include an inlet 128, an accumulation section 130, one or more gates 132, a transition section 134, an outlet 136, an optional second transition section 144 (see FIG. 6), and an optional second outlet 146 (see FIG. 6). Each of the sections 128, 130, 132, 134, 136, 144, 146 of the accumulation region 126 generally includes a plurality of rows of continuous electrodes 148 and a plurality of segmented electrode arrays 150, the number of which can vary between sections 128, 130, 132, 134, 136, 144, 146, as shown in FIG. 6. In this regard, some of the rows of continuous electrodes 148 and segmented electrode arrays 150 can extend through more than one section 128, 130, 132, 134, 136, 144, 146 with some extending through all sections 128, 130, 132, 134, 136, 144, 146 of the accumulation region 126, as shown in FIG. 6. The continuous electrodes 148 can be substantially similar to the continuous electrodes 118a-f shown and described in connection with FIG. 3, while the segmented electrode arrays 150 can be substantially similar to the plurality of segmented electrode arrays 120a-e shown and described in connection with FIG. 3. Similar to the segmented electrode arrays 120a-e, the segmented electrode arrays 150 can include a plurality of individual electrodes 122a-h. It is also noted that for the ease of illustration every continuous electrode 148, segmented electrode array 150, and individual electrode 122a-h is not labelled in FIG. 6, but instead a suitable representative number of elements are labelled.

The accumulation region 126 is configured to receive ions from the inlet region 124, e.g., through the inlet 128, accumulate ions in the accumulation section 130 by way of the one or more gates 132, and release the accumulated ions to the transition section 134. In this regard, the one or more gates 132 each include one or more gate electrodes 152a, 152b that can have a signal applied thereto to trap or prevent ions from continued propagation through the accumulation region 126. More specifically, the gate electrodes 152a, 152b can receive a high DC voltage signal from the controller 108 and in turn generate a high DC electric field (V/m) to trap ions within the accumulation section 130 as they are provided thereto by way of the inlet section 128. The accumulated ions are also retained laterally by DC guard electrodes 154 that flank the sections 128, 130, 132, 134, 136, 144, 146 of the accumulation region 126 and function in accordance with the guard electrodes 116 shown and described in connection with FIG. 3.

Once a desired number of ions are accumulated in the accumulation section 130, or a determination is made, e.g., by the controller 108 and/or computing device 110, that the accumulation section 130 is at maximum capacity, the high DC voltage signal can be removed from gate electrodes 152a and/or 152b and a traveling wave signal can be applied that is coordinated with the traveling wave signal applied to the other individual electrodes 122a-h within the accumulation section 130, as well as with the traveling wave signal applied to the transition section 134. Once the high DC voltage signal is removed and the traveling wave signal is applied, the ions will be urged through the transition section 134, through the outlet 136, and into the separation region 138. It is also noted that the optional second transition section 144 and optional second outlet 146 can be used to transfer the ions to a different section of the IMS device 104.

The separation region 138 is a long serpentine path that extends between the outlet 136 of the accumulation region 126 and the exit region 140 of the IMS device 104. A portion of the separation region 138 is shown in greater detail in FIG. 7. The separation region 138 includes a plurality of rows of continuous electrodes 118a-f and a plurality of segmented electrode arrays 120a-e that extend through a series of straight regions 156 connected by turn regions 158. As discussed in connection with FIG. 3, the segmented electrode arrays 120a-e each include a plurality of individual electrodes 122a-h that receive a voltage or current signal from the controller 108. The separation region 138 also includes guard electrodes 116. The separation region 138 is configured to receive ions from the accumulation region 126, transfer the received ions to the exit region 140, and separate the ions based on mobility as they are transferred.

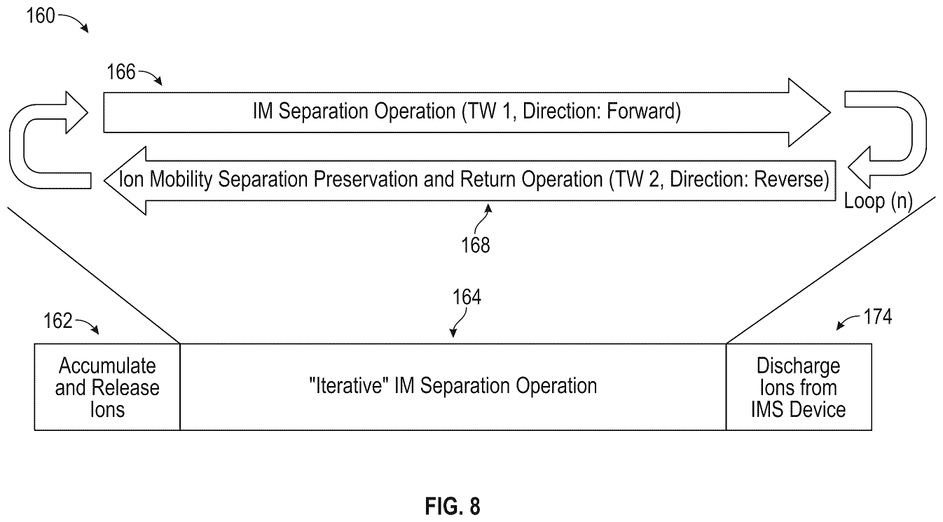

Notably, the straight regions 156 and the turn regions 158 are bidirectional such that they can transfer ions in a first forward direction and a second reverse direction that is different than, e.g., opposite to, the first forward direction. Accordingly, the turn regions 158 can be constructed in accordance with the curved turn regions disclosed in U.S. Patent App. Pub. No. 2023/0187194 entitled “Apparatus for Ion Manipulation Having Curved Turn Regions,” which is hereby incorporated by reference in its entirety. This bidirectional transmission functionality allows the IMS device 104 to separate ions based on mobility as they are transferred through the separation region 138 in the first direction, preserve the separated ions in the current separation state (e.g., maintains the relative degree of separation between the ions), and transfer the separated ions back through the separation region 138 in the second direction without further separating the ions, e.g., while maintaining the relative degree of separation between the ions, which is discussed in greater detail in connection with FIGS. 8-12.

FIG. 8 is an exemplary timetable 160 illustrating an exemplary sequence of operations performed by the IMS system 100. First, an accumulate and release operation 162 is performed, during which ions are accumulated in the accumulation region 126 and subsequently released into the separation region 138, e.g., after a fill capacity of the accumulation region 126 has been reached. Next, an iterative ion mobility separation operation 164 is performed on the ions that were released from the accumulation region 126 into the separation region 138 such that the ions are separated based on mobility through a repeating or looping series of events that form a separation cycle. In particular, the iterative ion mobility separation operation 164 includes a series of sub-operations that include an IM separation operation 166 and an ion mobility separation preservation and return operation 168. In some instances, the ion mobility separation preservation and return operation 168 can be performed as two separate operations, e.g., an independent ion separation preservation operation that stops the ions while preserving the relative degree of separation therebetween and an independent return operation that subsequently returns the ions while maintaining the relative degree of separation therebetween.

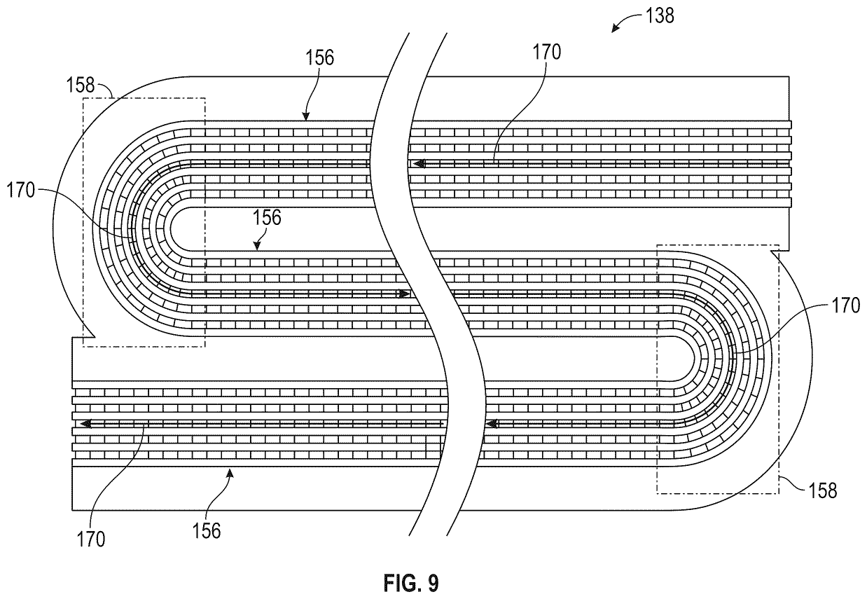

During the IM separation operation 166, a first voltage signal is applied to the individual electrodes 122a-h, which generates a first traveling wave potential that separates the ions based on mobility. The first traveling wave potential has a first set of characteristics, e.g., a first amplitude, first speed, etc., and travels in a first direction along a first path 170 that extends from the beginning of the separation region 138 to the end of the separation region 138, e.g., along the serpentine length thereof. The first traveling wave potential causes the ions to move in the first direction along the first path 170, and separates the ions based on mobility. The first path 170 is illustrated in FIG. 9, which is a schematic diagram of a portion of the separation region 138 showing the first path 170 extending therethrough and direction of ion travel.

Next, after a predetermined period of time, the ion mobility separation preservation and return operation 168 is performed. In particular, the first voltage signal is replaced with a second voltage signal that is applied to the individual electrodes 122a-h, which generate a second traveling wave potential that travels in a second direction along a second path 172 that extends from the end of the separation region 138 to the beginning of the separation region 138. Accordingly, the second path 172 and second direction are generally opposite to the first path 170 and the first direction. However, it should be understood that the first path 170 and the second path 172 can substantially overlap such that the first and second paths 170, 172 are the same, but the direction of travel of ions therethrough differs depending on the operation being performed, e.g., IM separation operation 166 or ion mobility separation preservation and return operation 168.

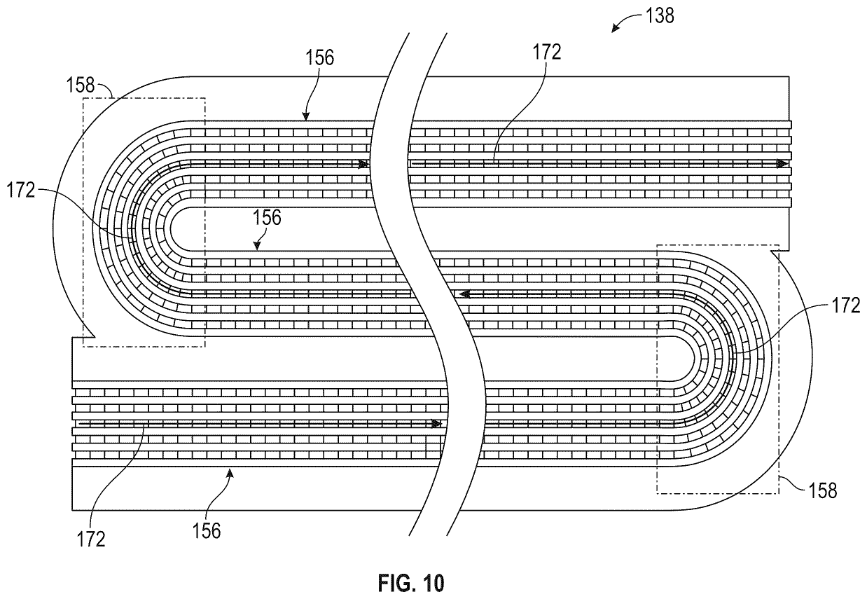

The second path 172 is illustrated in FIG. 10, which is a reproduction of FIG. 9 but with the first path 170 being replaced with the second path 172 and showing the direction of ion travel along the second path 172. The second traveling wave potential includes a second set of characteristics, e.g., a second amplitude, a second speed, etc., and is configured to preserve the separated ions in their current state of separation (e.g., maintain the relative degree of separation between the ions) and transfer the separated ions in the second direction along the second path 172 while maintaining the relative degree of separation therebetween. For example, the second traveling wave potential can have a sufficiently high amplitude and sufficiently low speed that ions do not traverse the peaks of the second traveling wave and therefore do not separate based on mobility, which would otherwise undo the prior separation, as they traverse the second path 172 in the second direction.

After a predetermined period of time, the IM separation operation 166 is performed a second time to further separate the ions based on mobility. The IM separation operation 166 and ion mobility separation preservation and return operation 168 can be iteratively performed as a loop as many times as desired during a full data acquisition cycle until sufficient ion separation and a desired IM resolution is achieved for the targeted mobility range of ions. This operation can essentially increase the operative path length along which ions are separated to hundreds or thousands of meters. After completing the IM separation operation 166 of the final loop, an exit operation 174 is performed in which the ions are discharged from the IMS device 104. In particular, the separated ions are transferred to exit region 140 and discharged through the deflector 142 into the mass spectrometer 106 for detection.

In addition to the foregoing, during the iterative ion mobility separation operation 164, portions of the IMS device 104 can be used to perform “ion dumping” in which ions are selectively eliminated, or removed and stored for future analysis. As the ions are separated by mobility during the IM separation operation 166, the lowest mobility ions will fall to the back of the ion group while the highest mobility ions will remain in the front of the ion group, which allows for the IMS device 104 to selectively eliminate or extract the lowest mobility ions and the highest mobility ions. In particular, the timing of the IM separation operation 166, as well as the transition from IM separation operation 166 to ion mobility separation preservation and return operation 168, can be set so that the highest mobility ions that first arrive at the end of the separation region 138 are transferred into the exit region 140 prior to switching to the ion mobility separation preservation and return operation 168. Those ions can then be either eliminated by the deflector 142, which can be an electrode that attracts and eliminates the ions, or transferred to a different region where they are stored and can be used in a future analysis. Similarly, when the ions are being returned to the beginning of the separation region 138 during the ion mobility separation preservation and return operation 168, the lowest mobility ions will be backed up against the accumulation region 126 and can be forced into the accumulation region 126. Those ions can then be either eliminated by the accumulation region 126, e.g., by applying a voltage signal to one or more electrodes of the accumulation region 126 that eliminates the ions, or transferred to a different region where they are stored and can be used in a future analysis. Alternatively, a switch can be used to intentionally divert ions to waste. Accordingly, the IMS device 104 performing the iterative ion mobility separation operation 164 can be used to selectively remove ions of lower or higher ion mobility than those of interest, which can allow for additional separations to be performed.

Additionally, the iterative ion mobility separation operation 164 and the “ion dumping” operation can be used together to selectively isolate ions within a mobility range of interest for further analysis. In particular, the “ion dumping” operation can be used to iteratively eliminate ions of higher mobility and ions of lower mobility as ions undergo the iterative ion mobility separation operation 164, which results in a narrowing of the mobility range of ions within the IMS device 104 as each iteration of the ion mobility separation operation 164 is performed. The “ion dumping” operation performed by the deflector 142 and the accumulation region 126 can be timed so that only ions outside of the targeted mobility range are eliminated or removed, and thus only ions within the targeted mobility range ultimately remain. The remaining ions can then be further analyzed, e.g., by fragmentation, reanalysis using the IMS device 104, or transmission to the mass spectrometer 106.

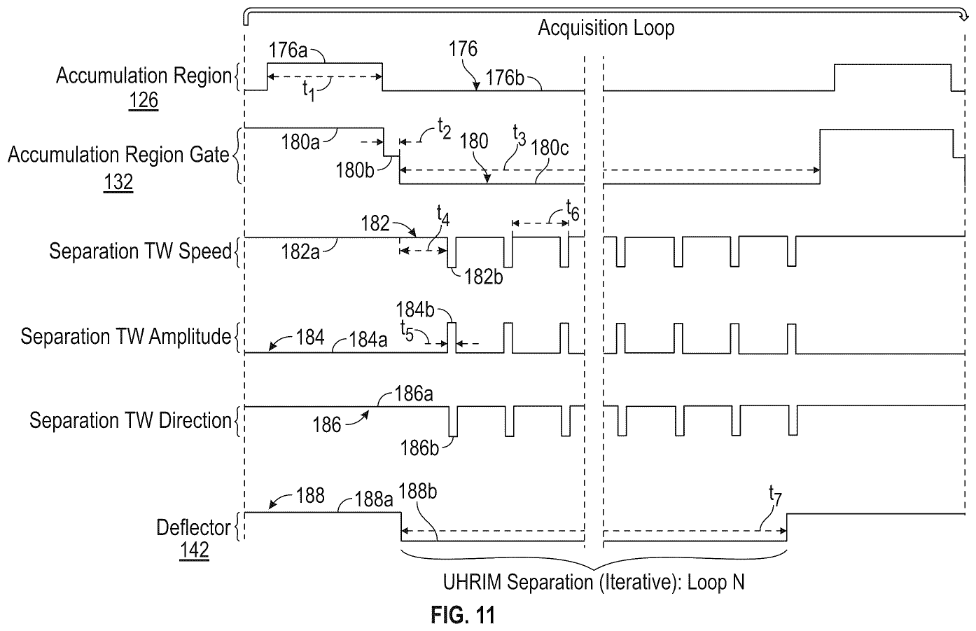

FIG. 11 is an exemplary timing diagram illustrating the timing of events and parameters governing operation of the IMS device 104 of the present disclosure. Line 176 indicates the timing for the provision of ions to the accumulation region 126. In particular, high signal 176a for line 176 indicates that ions are being provided from the inlet region 124 to the accumulation region 126 while low signal 176b indicates that ions are not being provided to the accumulation region 126, e.g., they are instead being provided from the inlet region to an ion detector 178 (see FIG. 5). Ions provided to the ion detector 178 are generally eliminated and not analyzed in the experiment. The first time period t₁ represents the fill time for the accumulation region 126, e.g., the time period during which ions are provided to the accumulation region 126 and accumulated in the accumulation section 130.

Line 180 represents the state of the gate 132 of the accumulation region 126. In particular, high signal 180a for line 180 represents that the gate 132 is activated, e.g., the gate electrodes 152a, 152b are receiving a high gating signal, and ions are being accumulated in the accumulation section 130. High signal 180a is generally active during the first time period t₁. Intermediate signal 180b for line 180 indicates that one or more of the gates 132 are deactivated, e.g., gate electrodes 152a and/or 152b are receiving a low gating signal, and ions are being released from the accumulation section 130, such that they are transferred through the transition section 134, through the outlet 136, and into the separation region 138. The second time period t₂ represents the time period during which ions are being released from the accumulation region 126 and transferred into the separation region 138. Low signal 180c for line 180 indicates that the gate 132 is being operated in an “ion dumping” mode, e.g., it is receiving a signal such that one or more gate electrodes 152a eliminate any ions that reenter or approach the accumulation region 126. Notably, the second time period t₂ is sufficiently long to ensure that all ions have exited the accumulation region 126 prior to the accumulation region 126 transitioning into “ion dumping” mode. The third time period t₃ represents the time period for which the gate 132 (or other portion of the accumulation region 126) is operated in “ion dumping” mode.

Line 182 represents the speed of the traveling wave potential in the separation region 138 with high signal 182a representing that the traveling wave potential has a high speed and low signal 182b representing that the traveling wave potential has a low speed. Line 184 represents the amplitude of the traveling wave potential in the separation region 138 with low signal 184a representing that the traveling wave potential has a low amplitude and high signal 184b representing that the traveling wave potential has a high amplitude. Line 186 represents the travel direction of the traveling wave potential in the separation region 138 with high signal 186a indicating that the traveling wave potential is traveling in the first direction (e.g., forward direction from the beginning to the end) along the first path 170 and low signal 186b indicating that the traveling wave potential is traveling the second direction (e.g., reverse direction from the end to the beginning) along the second path 172.

Accordingly, the combination of a high signal 182a for line 182, low signal 184a for line 184, and high signal 186a for line 186 indicates that the first traveling wave potential is being generated and the IM separation operation 166 is being performed, while the combination of a low signal 182b for line 182, high signal 184b for line 184, and low signal 186a for line 186 indicates that the second traveling wave potential is being generated and the ion mobility separation preservation and return operation 168 is being performed. Line 188 represents the state of the deflector 142. In particular, high signal 188a for line 188 represents that the deflector 142 is transmitting ions therethrough, e.g., to the mass spectrometer 106 or other downstream device, while low signal 188b for line 188 represents that the deflector 142 is being operated in an “ion dumping” mode, e.g., it is receiving a signal such that it eliminates any ions that enter the exit region 140. The seventh time period t₇ represents the time period for which the deflector 142 is operated in “ion dumping” mode.

The sixth time period to represents the completion of a single iterative ion mobility separation operation 164, which consists of a single IM separation operation 166 and a single ion mobility separation preservation and return operation 168. As can be seen in FIG. 11, the iterative ion mobility separation operation 164 can be looped and performed several times in succession as desired in order to complete a full ultra-high resolution ion mobility separation. Additionally, it should be understood that the fourth time period t₄ and the fifth time period t₅ can vary in length of time between separate experiments and within a single experiment, e.g., a full ultra-high resolution ion mobility separation. Moreover, while the fifth time period t₅ is shown as being shorter than the fourth time period t₄, it should be understood that, in some instances, the fifth time period t₅ can be equal to or longer than the fourth time period t₄ depending on different variables including the speeds and amplitudes of the traveling waves.

Thus, the IMS device 104 controls and adjusts the timing and characteristics of the separation field in order to manipulate ions in various ways and boost the ion mobility resolution of the IMS system 100 without requiring additional physical paths. The foregoing approach can be applied to various types of time dispersion IMS systems including those that are not already configured and designed for iterative ion mobility separations as it relies on adjusting timing and characterizes of the separation field, as opposed to an additional physical path that connects the end of a separation path to the beginning. That is, the foregoing approach can be implemented on standard systems without the need for additional system changes. Thus, the foregoing approach serves as a retroactive solution to obtain necessary HRIMS on IMS systems, e.g., SLIM systems, that are not currently capable of achieving UHRIMS. This allows for such systems to be used for certain applications that they were not previously capable of being use for, such as separating isomers with close mobilities.

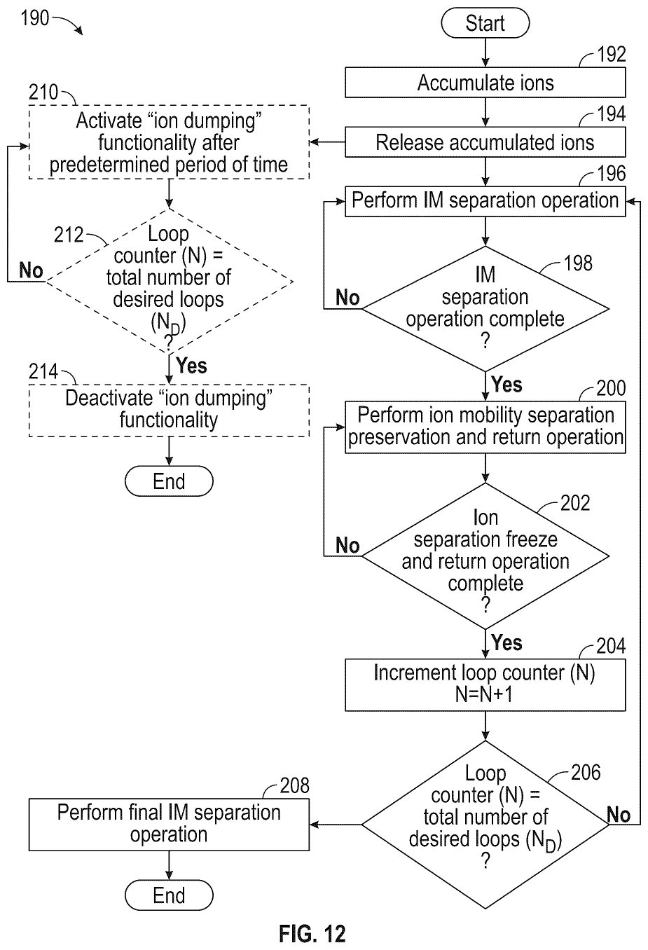

FIG. 12 is a flowchart 190 illustrating exemplary steps for performing iterative ion mobility separations. In step 192, ions are accumulated in the accumulation region 126. Step 192 can include activating the gate 132, receiving ions in the accumulation section 130 through the inlet 128, and preventing ions from exiting the accumulation section 130 using the gate 132. Next, in step 194, ions are released from the accumulation region 126, which can include deactivating the gate 132 to allow ions to traverse the transition section 134 and the outlet 136, and enter the separation region 138.

In step 196, the IM separation operation 166 is performed, e.g., the separation region 138 is operated in IM separation mode. In particular, the separation region 138 generates the first traveling wave potential that travels in the first direction, causes ions to travel in the first direction along the first path 170, and separates the ions based on mobility. Next, in step 198, a determination is made as to whether the IM separation operation 166 is complete, which can be a time-based determination, e.g., has the IM separation operation 166 been operational for greater than a predetermined period of time. If a negative determination is made in step 198, e.g., the IM separation operation 166 is not complete, then the process returns to step 196. If a positive determination is made in step 198, e.g., the IM separation operation 166 is complete, then the process proceeds to step 200.

In step 200, the ion mobility separation preservation and return operation 168 is performed, e.g., the separation region 138 is operated in ion separation preservation and return mode. In particular, the separation region 138 generates the second traveling wave potential that travels in the second direction, preserves the separated ions in their current state of separation (e.g., maintains the relative degree separation between the ions), and causes the separated ions to travel in the second direction along the second path 172 while maintaining the relative degree of separation of the ions. Next, in step 202, a determination is made as to whether the ion mobility separation preservation and return operation 168 is complete, which can be a time-based determination. If a negative determination is made in step 202, e.g., the ion mobility separation preservation and return operation 168 is not complete, then the process returns to step 200. If a positive determination is made in step 202, e.g., the ion mobility separation preservation and return operation 168 is complete, then the process proceeds to step 204.

In step 204, a loop counter (N) is incremented (N=N+1) to monitor how many iterative ion mobility separation operations 164 have been performed, e.g., how many separation loops have been performed. Next, in step 206 the loop counter (N) is compared to a total number of desired loops (Np). If the loop counter (N) is not equal to the total number of desired loops (ND) then the process returns to step 196 and the iterative ion mobility separation operation 164 is performed again. That is, steps 196, 198, 200, 202, and 204 are repeated such that the IM separation operation 166 and the ion mobility separation preservation and return operation 168 are repeated. If, in step 206, it is determined that the loop counter (N) equals the total number of desired loops (ND) then the process proceeds to step 208 and the IM separation operation 166 is performed one last time and the process ends. The separated ions can then be transferred to the mass spectrometer 106 for detection and analysis.

Turning back to step 194, after the accumulated ions are released, an optional “ion dumping” sub-process can be performed. In particular, optional step 210 can be performed in which the optional “ion dumping” functionality is activated after a predetermined period of time, which is implemented to ensure that all ions have exited the accumulation region 126 before the “ion dumping” functionality is activated. This can involve switching the accumulation region 126 and the deflector 142 to “ion dumping” mode in which they are configured to eliminate, discard, or redirect ions that are provided thereto. Notably, step 196 and step 200 can be timed so that only undesired ions are provided to the accumulation region 126 and the deflector 142. In optional step 212, the loop counter (N) is compared to the total number of desired loops (ND). If the loop counter (N) is not equal to the total number of desired loops (ND) then the process returns to optional step 210 and the “ion dumping” functionality remains activated. If, in optional step 212, it is determined that the loop counter (N) equals the total number of desired loops (ND) then the process proceeds to step 214 and the “ion dumping” functionality is deactivated to ensure that no further ions are eliminated by the deflector 142, and the sub-process ends.

The foregoing processes result in ultra-high resolution ion mobility separations, as small regions of the mobility spectrum can be isolated and analyzed, while ions outside of that small region can be eliminated.

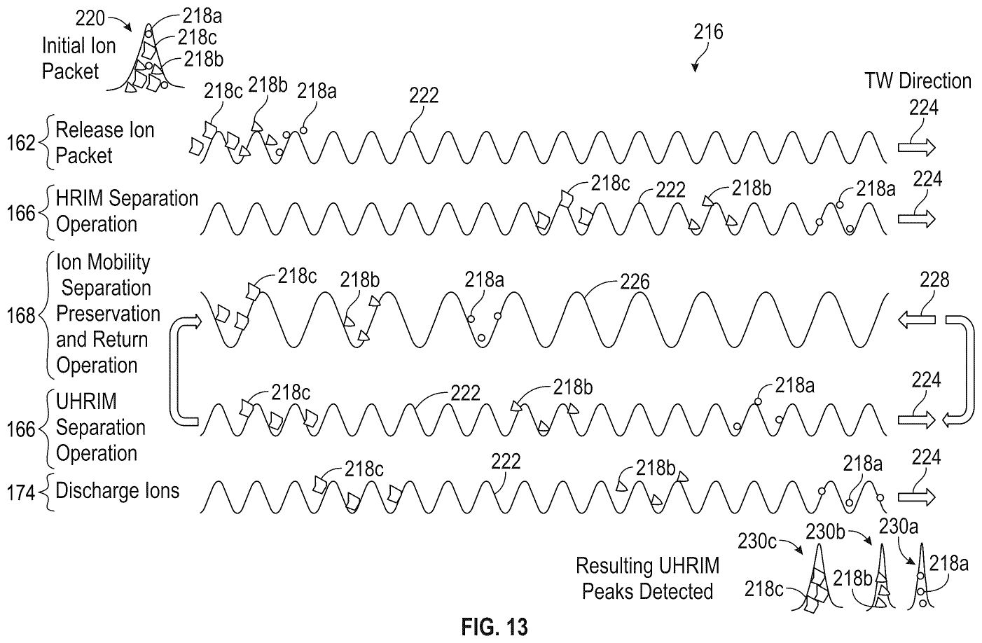

FIG. 13 is a diagram 216 illustrating the traveling wave potentials, including speeds, amplitudes, and directions thereof, during each phase of the iterative ion mobility separation process and the resulting separation of ions. As mentioned in connection with FIGS. 4 and 8, the IMS device 104 first performs an accumulate and release operation 162 during which ions 218a, 218b, 218c having different mobilities are accumulated in the accumulation region 126 into an ion packet 220 and then released into the separation region 138. During the release operation 162, the separation region 138 generates a first traveling wave potential 222. The first traveling wave potential 222 has a first speed (or frequency) and a first amplitude, and travels in a first direction 224, e.g., a forward direction. Next, the IM separation operation 166 is performed using the first traveling wave potential 222. As can be seen in FIG. 13, the first traveling wave potential 222 causes the ions 218a, 218b, 218c to separate based on mobility with the ions having the lowest mobility, e.g., ions 218c, falling to the back.

After a predetermined period of time, or once the highest mobility ions, e.g., ions 218a, at the front of the now separated ion packet 220 arrive at the end of the separation region 138, the first traveling wave potential 222 is replaced with a second traveling wave potential 226 and the ion mobility separation preservation and return operation 168 is performed. The second traveling wave potential 226 has a second speed (or frequency) and a second amplitude, and travels in a second direction 228 that is opposite to the first direction 224, e.g., the first direction 224 is a forward direction and the second direction 228 is a reverse direction. The second speed (or frequency) can be less than the first speed (or frequency) while the second amplitude can be greater than the first amplitude. During the ion mobility separation preservation and return operation 168, the second traveling wave potential 226 preserves the separated ions 218a, 218b, 218c in their current state of separation (e.g., maintains the relative degree separation between the ions) and causes the separated ions to travel in the second direction 228 while maintaining their relative degree of separation, e.g., without undergoing further separation or diffusion. That is, the second traveling wave potential 226 “surfs” the ions in the second direction 228.

After a predetermined period of time, or once the lowest mobility ions, e.g., ions 218c, at the rear of the now separated ion packet 220 arrive at the beginning of the separation region 138, the IM separation operation 166 is performed with the first traveling wave potential 222 a second time to further separate the ions 218a, 218b, 218c based on mobility, thus resulting in an UHRIM separation. The IM separation operation 166 and ion mobility separation preservation and return operation 168 can be iteratively performed as a loop as many times as desired during a full data acquisition cycle until sufficient ion separation and a desired IM resolution is achieved for the targeted mobility range of ions. After completing the IM separation operation 166 of the final loop, the exit operation 174 is performed in which the ions are discharged from the IMS device 104. The ions 218a, 218b, 218c are then detected by the mass spectrometer 106 and the resulting UHRIM peaks 230a, 230b, 230c are shown in FIG. 13.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. The features illustrated or described in connection with one exemplary embodiment may be combined with the features of other embodiments. Such modifications and variations are intended to be included within the scope of the present disclosure. Further, in the present disclosure, like-named components of the embodiments generally have similar features, and thus within a particular embodiment each feature of each like-named component is not necessarily fully elaborated upon.

What is claimed is:

1. A method of separating ions based on mobility, comprising:
receiving ions by an ion mobility spectrometry device having a separation region;
causing the ions to travel through at least a portion of the separation region in a first direction along a path and separate based on ion mobility;
causing the separated ions to maintain a relative degree of separation therebetween and travel in a second direction along the path while maintaining the relative degree of separation therebetween, the second direction being opposite to the first direction; and
causing the ions to travel in the first direction along the path a second time to further separate the ions based on ion mobility.

2. The method of claim 1, comprising:
accumulating ions in an accumulation region of the ion mobility spectrometry device; and
releasing the ions accumulated in the accumulation region into the separation region.

3. The method of claim 1, wherein causing the ions to travel through at least a portion of the separation region in a first direction along a path includes:
generating a first traveling wave potential in the separation region, the first traveling wave potential causing the ions to travel in the first direction along the path and separate based on ion mobility; and
wherein causing the separated ions to maintain a relative degree of separation therebetween and travel in a second direction along the path includes:
generating a second traveling wave potential in the separation region, the second traveling wave potential causing the separated ions to maintain the relative degree of separation therebetween and travel in the second direction along the path while maintaining the relative degree of separation therebetween.

4. The method of claim 3, wherein the first traveling wave potential includes a first speed and a first amplitude, and the second traveling wave potential includes (a) a second speed that is less than the first speed, (b) a second amplitude that is greater than the first amplitude, or (c) a second speed that is less than the first speed and a second amplitude that is greater than the first amplitude.

5. The method of claim 1, wherein the ion mobility spectrometry device is a structures for lossless ion manipulations (SLIM) device.

6. The method of claim 1, wherein the path extends from a beginning of the separation region to an end of the separation region.

7. The method of claim 1, comprising:
selectively removing a portion of the ions from the separation region.

8. The method of claim 7, wherein selectively removing a portion of the ions from the separation region includes activating an electrode positioned upstream of the separation region to eliminate the portion of the ions.

9. The method of claim 7, wherein selectively removing a portion of the ions from the separation region includes activating an electrode positioned downstream of the separation region to eliminate the portion of the ions.

10. The method of claim 7, wherein selectively removing a portion of the ions from the separation region includes:
activating a switch to remove the portion of the ions from the separation region, and
storing the portion of the ions that have been removed.

11. An ion mobility spectrometry device for separating ions based on mobility, comprising:
a separation region receiving ions; and
a path extending through at least a portion of the separation region,
wherein the ion mobility spectrometry device:
causes the ions received by the separation region to travel through at least a portion of the separation region in a first direction along the path and separate based on ion mobility,
causes the separated ions to maintain a relative degree of separation therebetween and travel in a second direction along the path while maintaining the relative degree of separation therebetween, the second direction being opposite to the first direction, and
causes the ions to travel in the first direction along the path a second time to further separate the ions based on ion mobility.

12. The ion mobility spectrometry device of claim 11, comprising:
an accumulation region, the accumulation region accumulating ions and releasing the accumulated ions into the separation region.

13. The ion mobility spectrometry device of claim 11, comprising:
a plurality of electrodes positioned within the separation region, the plurality of electrodes generating a first traveling wave potential and a second traveling wave potential.

14. The ion mobility spectrometry device of claim 13, wherein the first traveling wave potential causes the ions received by the separation region to travel in the first direction along the path and separate based on ion mobility, and the second traveling wave potential causes the separated ions to maintain the relative degree of separation therebetween and travel in the second direction along the path while maintaining the relative degree of separation therebetween.

15. The ion mobility spectrometry device of claim 13, wherein the first traveling wave potential includes a first speed and a first amplitude, and the second traveling wave potential includes (a) a second speed that is less than the first speed, (b) a second amplitude that is greater than the first amplitude, or (c) a second speed that is less than the first speed and a second amplitude that is greater than the first amplitude.

16. The ion mobility spectrometry device of claim 11, wherein the ion mobility spectrometry device is a structures for lossless ion manipulations (SLIM) device.

17. The ion mobility spectrometry device of claim 11, wherein the path extends from a beginning of the separation region to an end of the separation region.

18. The ion mobility spectrometry device of claim 11, comprising an electrode positioned upstream of the separation region,
wherein the electrode selectively eliminates a portion of the ions.

19. The ion mobility spectrometry device of claim 11, comprising an electrode positioned downstream of the separation region,
wherein the electrode selectively eliminates a portion of the ions.

20. The ion mobility spectrometry device of claim 11, comprising:
a switch, the switch selectively removing a portion of the ions from the separation region; and
an accumulation region, the accumulation region storing the portion of the ions that have been removed.
